(19) United States
(12) Patent Application Publication
(10) Pub. No.: US 2005/0109434 A1
(43) Pub. Date: May 26, 2005

(54) Separator for fuel cell

(75) Inventors: Do-young Seung, Seoul (KR); Wook Sun, Gyeonggi-do (KR); Duck-young Yoo, Seoul (KR); Jung-ock Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/798,882

(22) Filed: Mar. 12, 2004

(30) Foreign Application Priority Data
Aug. 22, 2003 (KR) 2003-58284

(51) Int. Cl. C22C 45/00; H01M 2/16

(52) U.S. Cl. 148/561; 148/403; 429/34

(57) ABSTRACT

A separator of a fuel cell and a method of preparing the separator include improvements in processability and corrosion resistance. The separator of the fuel cell is made of a solid-state, amorphous alloy.

### CROSS-REFERENCE TO RELATED APPLICATIONS

This application claims the benefit of Korean Application No. 2003-58284, filed Aug. 22, 2003, in the Korean Intellectual Property Office, the disclosure of which is incorporated herein by reference in its entirety.

### BACKGROUND OF THE INVENTION

1. Field of the Invention

The present invention relates to a fuel cell, and more particularly, to a separator for a fuel cell.

2. Description of the Related Art

Fuel cells involve the following operating mechanism. First, fuel, such as hydrogen, natural gas, or methanol, is oxidized at an anode to produce electrons and hydrogen ions. The hydrogen ions produced at the anode travel through an electrolyte membrane to a cathode. The electrons produced at the anode are fed into an external circuit through a conductive line. At the cathode, the hydrogen ions, the electrons fed into the cathode through the external circuit, and oxygen (including air that contains oxygen) react to produce water.

There is an increasing interest in fuel cells as next generation energy conversion devices that have a high efficiency of electricity generation and are environment-friendly. Fuel cells are classified into polymer electrolyte membrane fuel cells (PEMFCs), phosphoric acid fuel cells (PAFCs), molten carbonate fuel cells (MCFCs), and solid oxide fuel cells (SOFCs), according to the type of an electrolyte used in the cells. An operating temperature and materials for constitutional elements of fuel cells depend on the fuel cell type.

PEMFCs may be operated at a relatively low temperature of about 80° C. to about 120° C., have a very high power density, and thus may be used as automobile and domestic power sources. A bipolar plate is an essential element of PEMFCs that should be improved to obtain small, lightweight, and inexpensive PEMFCs.

A bipolar plate and a membrane electrode assembly (MEA) are main elements of PEMFCs. The MEA includes an anode at which fuel is oxidized, a cathode at which an oxidizing agent is reduced, and an electrolyte membrane interposed between the anode and the cathode. The electrolyte membrane has ionic conductivity to transport hydrogen ions generated in the anode to the cathode and an electron-insulating property to provide electron insulation between the anode and the cathode.

As is well known in the art, a bipolar plate includes a channel for the flow of fuel and air and serves as an electron conductor for electron transfer between MEAs. In this regard, the bipolar plate must satisfy requirements such as non-porosity for separating fuel and air, effective electrical conductivity, sufficient thermal conductivity to control the temperature of a fuel cell, sufficient mechanical strength to withstand a clamping force for a fuel cell, and corrosion resistance to hydrogen ions.

Conventionally, a graphite plate had been mainly used as a bipolar plate for PEMFCs. In this case, a channel for fuel and air is mainly formed by a milling process. The graphite plate has advantages such as effective electrical conductivity and a desirable corrosion resistance. However, a material cost and a milling process cost for the graphite plate comprise the major portion of the high cost of a bipolar plate. In addition, since the graphite plate is brittle, it is very difficult to process it to a thickness of 2 to 3 mm. Due to such a thickness of the graphite plate, there is a limitation on the size reduction of a fuel cell stack made up of several tens to several hundreds of unit cells.

To reduce the processing cost and thickness of a bipolar plate, a carbon-polymer composite and a metal have been suggested as an alternative material for a bipolar plate.

In the case of the carbon-polymer composite, a bipolar plate is easily mass-produced at a low processing cost by a molding process, such as compression molding or injection molding. However, essential physical properties for a bipolar plate, such as electrical conductivity, mechanical strength, and gas-tight sealing are not easily ensured.

In the case of the metal, due to corrosion of the metal used, there arise serious problems, such as membrane poisoning and increased contact resistance. A metal satisfies most of the physical properties necessary for a bipolar plate, and the material and processing costs of the metal bipolar plate are very low. In particular, it is expected that the cost of a metal bipolar plate used in a PEMFC will be less than 1/100 of the cost of a graphite bipolar plate. However, it is known that a metal is not suitable as a material for a bipolar plate due to corrosion caused by the acidic environment of the inside of a fuel cell. For example, a PEMFC using a bipolar plate made of stainless steel, a Ti alloy, or a Ni alloy exhibits ineffective performance after 1,000 hours of performance testing, as compared to the performance of a graphite bipolar plate.

A surface coating method to improve corrosion resistance of a metal bipolar plate is known. For example, a bipolar plate made of Ti or stainless steel is coated with a material with excellent corrosion resistance and electrical conductivity, for example, TiN. However, even in the presence of only a few defects or pinholes, corrosion begins at these defects or pinholes and spreads gradually with time, thus forming local holes on a bipolar plate, which may be detrimental to the overall fuel cell system.

Generally, metal corrosion takes place in any environment. However, the corrosion rate varies significantly according to the environment in which a metal is placed. Metal corrosion is accelerated by an operating temperature of a PEMFC (i.e., about 80 to 120° C.), water produced by an electrochemical reaction at a cathode, an acidic electrolyte contacting with a bipolar plate, a crevice formed at a bipolar plate that contacts an MEA, hydrogen, and the like. It is very difficult to select a metal that is resistant in this corrosive environment during the life span of a fuel cell.

Corrosion of a metal bipolar plate may cause electrolyte poisoning by diffusion of metal ions into an electrolyte membrane, as well as causing defects on the bipolar plate. Electrolyte poisoning may lower hydrogen ionic conductivity of an electrolyte, thus decreasing the performance of a fuel cell.

The above descriptions about a bipolar plate may also be applied to an end plate, a cooling plate, and a separator.

As is well known in the art, an end plate is an electron-conductive plate having a channel for fuel or an oxidizing agent on only a surface thereof. The end plate is attached to each of the MEAs positioned on both ends of a fuel cell stack.

As is well known in the art, a cooling plate is an electron-conductive plate, a surface of which has a channel for fuel or an oxidizing agent, and the other surface has a channel for a cooling fluid.

As is well known in the art, when an anode and a cathode include the channels, a separator may be used to physically separate reactants of an anode and a cathode, in particular, gaseous reactants (for example, oxygen, hydrogen, and the like) and may electrically connect adjacent unit cells. In this regard, the separator must have low gas permeability, effective electrical conductivity, effective corrosion resistance, and effective thermal conductivity. In the present specification, such a separator will be referred to as “a separator in a narrow sense”, and the term “separator (or separating plate)” includes a bipolar plate, an end plate, a cooling plate, and a separator in a narrow sense.

The above-described problems about a separator used in PEMFCs may also arise in PAFCs, DMFCs, and the like.

### SUMMARY OF THE INVENTION

The present invention provides a separator of a fuel cell, and a fuel cell having the separator, with improvements in processability and corrosion resistance.

The present invention also provides a method of manufacturing a separator of a fuel cell, with improvements in processability and corrosion resistance.

According to an aspect of the present invention, a separator of a fuel cell may comprise a solid-state, amorphous alloy.

According to another aspect of the present invention, a method of manufacturing a separator of a fuel cell which comprises a solid-state, amorphous alloy may include: preparing a melt to form the solid-state, amorphous alloy; feeding the melt into a mold provided with a mold cavity having a shape corresponding to the separator; and cooling the melt in the mold cavity at a cooling rate higher than the critical cooling rate to transform the melt into an amorphous phase.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a schematic diagram showing an overall configuration of an example of a fuel cell having separators in accordance with an embodiment of the present invention.

FIG. 2 is a flowchart of an embodiment of a method in accordance with an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

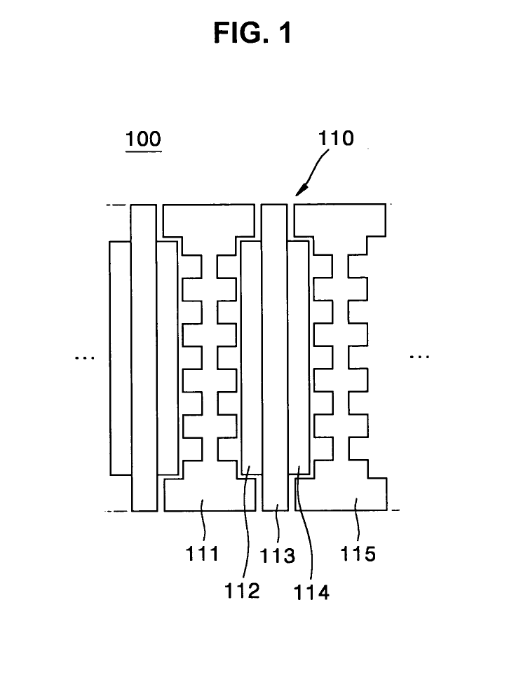

The present invention provides a separator of a fuel cell which comprises a solid-state, amorphous alloy. FIG. 1, numeral 100, is a schematic diagram (not to scale) showing an overall configuration of a fuel cell 110, wherein the fuel cell 110 may be one of a stack of fuel cells, having separators 111, 115 in accordance with an embodiment of the present invention. The fuel cell 110 has an electrolyte membrane 113 interposed between the anode 112 and the cathode 114, wherein the electrolyte membrane is on a first side of the anode and the cathode, and at least one separator proximate to one of: the anode 112 and the cathode 114, the at least one separator 111, 115 being disposed on a side of the anode 112/cathode 114 opposite to the electrolyte membrane 113, and comprising a solid-state, amorphous alloy.

In the embodiment shown, separators 111,115 channel fuel or gas feeds and are located adjacent to the anode 112 and the cathode 114. Numerous embodiments of fuel cells may be implemented, as is known to those skilled in the art, and will not be described herein.

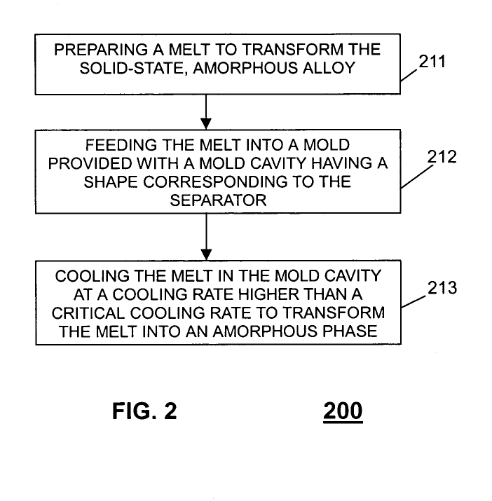

As shown in FIG. 2, numeral 200, the present invention also includes a method 200 of manufacturing a separator of a fuel cell which comprises a solid-state, amorphous alloy, wherein the method comprises: preparing a melt to transform the amorphous alloy 211; feeding the melt into a mold provided with a mold cavity having a shape corresponding to the separator 212; and cooling the melt In the mold cavity at a cooling rate higher than the critical cooling rate to transform the melt into an amorphous phase 213.

A solid-state, amorphous alloy has superior mechanical strength and corrosion resistance, compared to a crystalline metal. Also, an amorphous alloy may be in a liquid state at a relatively low temperature, for example, about 750° C., and may be formed by a molding process, in similar fashion to forming a plastic material. Therefore, an amorphous alloy is a material with excellent processability.

A bipolar plate made of a solid-state, amorphous alloy according to an embodiment of the present invention may overcome a corrosion phenomenon, which is a highly significant problem of a conventional metal bipolar plate, and may substitute for a conventional, expensive graphite bipolar plate. In addition, a bipolar plate according to an embodiment of the present invention may be formed to a thinner thickness and a smaller weight than the thickness and weight of a conventional graphite bipolar plate, thus enhancing the power density of a fuel cell.

A bipolar plate of the present invention holds effective mechanical properties derived from an amorphous alloy, and thus, may be more efficiently applied in a fuel cell, relative to a graphite bipolar plate. For example, a bipolar plate of an embodiment of the present invention has enhancements in physical properties such as electrical conductivity, thermal conductivity, elastic limit, fracture toughness, non-permeability of gas, non-wettability in water, and yield strength, as compared to a graphite bipolar plate.

Specifically, a bipolar plate used in a PEMFC is required to have 10⁻⁷ (mbar·I)/(s·cm) or less of gas permeability, 10 S/cm or more of electrical conductivity, 20 W/(m·K) or more of thermal conductivity, and a surface oxide layer with electrical conductivity. A bipolar plate of the present invention more than satisfies such physical properties.

There are no particular limitations on an amorphous alloy that may be used herein. For example, the following amorphous alloys may be used.

Amorphous alloys having compositions disclosed in U.S. Pat. No. 5,288,344 may be used. According to U.S. Pat. No. 5,288,344, an amorphous alloy may be represented by the formula, (Zr₁₋ₓTiₓ)ₐ₁ETMₐ₂(Cu_{1-y}Ni_{y})_{b1}LTM_{b2}Be_{c}, where x and y are atomic fractions and a1, a2, b1, b2, and c are atomic percentages (atomic %), wherein ETM is at least one early transition metal selected from the group consisting of V, Nb, Hf, and Cr where the atomic % of Cr is less than 0.2a1, LTM Is a late transition metal selected from the group consisting of Fe, Co, Mn, Ru, Ag, and Pd, a2 is 0 to 0.4a1, x is 0 to 0.4, and y is 0 to 1, and wherein (i) when x is 0 to 0.15, (a1+a2) is 30 to 75%, (b1+b2) is 5 to 52%, b2 is 0 to 25%, and c is 6 to 47%, and (ii) when x is 0.15 to 0.4, (a1+a2) is 30 to 75%, (b1+b2) is 5 to 52%, b2 Is 0 to 25%, and c is 5 to 47%. The amorphous alloy may further contain a trace of Al, Si, Ge, or B.

U.S. Pat. No. 5,288,344 also discloses an amorphous alloy represented by the formula, (Zr₁₋ₓTiₓ)ₐ₁ETMₐ₂(Cu_{1-y}Ni_{y})_{b1}LTM_{b2}Be_{c}, where x and y are atomic fractions and a1, a2, b1, b2, b3, and c are atomic %, wherein ETM is at least one early transition metal selected from the group consisting of V, Nb, Hf, and Cr where the atomic % of Cr is 0.2a1 or less, LTM is a late transition metal selected from the group consisting of Fe, Co, Mn, Ru, Ag, and Pd, a2 is 0 to 0.4a1, x is 0.4 to 1, y Is 0 to 1, wherein when (b1+b2) is 10 to 43, 3c is (100−b1−b2) or less, and wherein (1) when x is 0.4 to 0.6, (a1+a2) is 35 to 75%, (b1+b2) is 5 to 52%, b2 is 0 to 25%, and c is 5 to 47%, (ii) when x is 0.6 to 0.8, (a1+a2) is 38 to 75%, (b1+b2) is 5 to 52%, b2 is 0 to 25%, and c is 5 to 42%, and (iii) when x is 0.8 to 1, (a1+a2) is 38 to 75%, (b1+b2) is 5 to 52%, b2 is 0 to 25%, and c is 5 to 30%. The amorphous alloy may further contain a trace of Al, Si, Ge, or B.

U.S. Pat. No. 5,288,344 also discloses an amorphous alloy represented by the formula, (Zr₁₋ₓTiₓ)ₐ(Cu_{1-y}Ni_{y})_{b}Be_{c}, where x and y are atomic fractions, and a, b, and c are atomic %, wherein x is 0 to 0.4, and y is 0 to 1, and wherein (i) when x is 0 to 0.15, a is 30 to 75%, b is 5 to 52%, and c is 6 to 47%, and (ii) when x is 0.15 to 0.4, a is 30 to 75%, b is 5 to 52%, and c is 6 to 47%.

U.S. Pat. No. 5,288,344 also discloses an amorphous alloy represented by the formula, (Zr₁₋ₓTiₓ)ₐ(Cu_{1-y}Ni_{y})_{b}Be_{c}, where x and y are atomic fractions, and a, b, and c are atomic %, wherein x is 0.4 to 1, y is 0 to 1, b is 10 to 43, wherein when b is 10 to 43, 3c is (100-b) or less, and wherein (i) when x is 0.4 to 0.6, a is 35 to 75%, b is 5 to 52%, and c is 5 to. 47%, (ii) when x is 0.6 to 0.8, a is 38 to 75%, b is 5 to 52%, and c is 5 to 42%, and (iii) when x is 0.8 to 1, a is 38 to 75%, b is 5 to 52%, and c is 5 to 30%.

U.S. Pat. No. 5,288,344 also discloses an amorphous alloy represented by the formula, ((Zr, Hf, Ti)ₓETM₁₋ₓ)ₐ(Cu_{1-y}Ni_{y})_{b1}LTM_{b2}Be_{c}, where x and y are atomic fractions, a, b1, b2, and c are atomic %. Here, the atomic fraction of Ti in the ((Zr, Hf, Ti)ETM) moiety is less than 0.7, x is 0.8 to 1, LTM is a late transition metal selected form Ni, Cu, Fe, Co, Mn, Ru, Ag, and Pd, ETM is an early transition metal selected from V, Nb, Y, Nd, Gd, other rare earth metals, Cr, Mo, Ta, and W, a is 30 to 75%, (b1+b2) is 5 to 52%, and c is 6 to 45%.

U.S. Pat. No. 5,288,344 also discloses an amorphous alloy represented by the formula, ((Zr, Hf, Ti)ₓETM₁₋ₓ)ₐCu_{b1}Ni_{b2}LTM_{b3}Be_{c}, where x is an atomic fraction, a, b1, b2, b3, and c are atomic %, LTM is a late transition metal selected form Ni, Cu, Fe, Co, Mn, Ru, Ag, and Pd, x is 0.5 to 0.8, and ETM is an early transition metal selected from V, Nb, Y, Nd, Cd, other rare earth metals, Cr, Mo, Ta, and W. When ETM is selected from Y, Nd, Cd, and other rare earth metal, a is 30 to 75%, (b1+b2+b3) is 6 to 50%, b3 is 0 to 25%, b1 is 0 to 50%, and c is 6 to 45%. When ETM is selected from Cr, Mo, Ta, and W, a is 30 to 60%, (b1+b2+b3) is 10 to 50%, b3 is 0 to 25%, b1 is 0 to x(b1+b2+b3)/2, and c is 10 to 45%. When ETM is V or Nb, a is 30 to 65%, (b1+b2+b3) is 10 to 50%, b3 is 0 to 25%, b1 is 0 to x(b1+b2+b3)/2, and c is 10 to 45%.

U.S. Pat. No. 5,618,359 discloses an amorphous alloy including 5 to 20 atomic % of Ti, 8 to 42 atomic % of Cu, 30 to 57 atomic % of an early transition metal selected from Zr and Hf, and 4 to 37 atomic % of a late transition metal selected from Ni and Co.

U.S. Pat. No. 5,618,359 also discloses an amorphous alloy represented by the formula, Tiₐ(ETM)_{b}(Cu₁₋ₓ(LTM)ₓ)ₓ. Here, ETM is selected from Zr and Hf, LTM is selected from Ni and Co, x is an atomic fraction, a, b, and c are atomic %, a is 19 to 41, b is 4 to 21, c is 49 to 64, 2<xc<14, and b<10+(11/17)(41−a). When 49<c<50, xc<8. When 50<c<52, xc<9. When 52<c<54, xc<10. When 54<c<56, xc<12. When 56<c, xc<14.

U.S. Pat. No. 5,618,359 also discloses an amorphous alloy represented by the formula, (ETM₁₋ₓTiₓ)ₐCu_{b}(Ni_{1-y}Co_{y})_{c}. Here, ETM Is selected from Zr and Hf, x and y are atomic fractions, a, b, and c are atomic %, x is 0.1 to 0.3, yc is 0 to 18, a is 47 to 67, b is 8 to 42, and c is 4 to 37. When a is 60 to 67 and c is 13 to 32, b>8+(12/7)(a−60). When a is 60 to 67 and c is 4 to 13, b≧20+(19/10)(76−a). When a is 47 to 55 and c is 11 to 37, b≧8+(34/8)(55-a).

U.S. Pat. No. 5,735,975 discloses an amorphous alloy including 45 to 65 atomic % of Zr; 5 to 15 atomic % of Zn; 4 to 7.5 atomic % of Ti or Nb; and a balance selected from Cu, Ni, Co, and up to 10 atomic % of Fe, wherein the ratio of Cu to (Ni+Co) is in a range of 1:2 to 2:1.

U.S. Pat. No. 5,735,975 also discloses an amorphous alloy including 52.5 to 57.5 atomic % of Zr; about 5 atomic % of Ti or Nb; 7.5 to 12.5 atomic % of Zn; 15 to 19.3 atomic % of Cu; and 11.6 to 16.4 atomic % of Ni or Co.

U.S. Pat. No. 5,735,975 also discloses an amorphous alloy including 56 to 58 atomic % of Zr; 5 atomic % of Nb; 7.5 to 12.5 atomic % of Zn; 13.8 to 17 atomic % of Cu; and 11.2 to 14 atomic % of Ni or Co.

U.S. Patent Application Laid-Open Publication No. 2003-0062811 discloses an amorphous alloy represented by the formula, (Zr, Ti)ₐ(Ni, Cu, Fe)_{b} where a is 30 to 95 atomic % and b is 5 to 70 atomic %.

U.S. Patent Application Laid-Open Publication No. 2003-0062811 also discloses an amorphous alloy represented by the formula, (Zr, Ti)ₐ(Ni, Cu, Fe)_{b}(Be, Al, Si, B)_{c} where a is 30 to 75 atomic %, b is 5 to 60 atomic %, and c is 0.01 to 50 atomic %.

U.S. Patent Application Laid-Open Publication No. 2003-0062811 also discloses an amorphous alloy represented by the formula, (Zr, Ti)ₐ(Ni, Cu)_{b}(Be)_{c} where a is 40 to 75 atomic %, b is 5 to 50 atomic %, and c is 5 to 50 atomic %.

U.S. Patent Application Laid-Open Publication No. 2003-0062811 also discloses an amorphous alloy represented by the formula, (Zr)ₐ(Ni,Cu)_{c}(Al)_{d}, where a is 40 to 65 atomic %, c is 20 to 30 atomic %, and d is 7.5 to 15 atomic %.

U.S. Patent Application Laid-Open Publication No. 2003-0062811 also discloses an amorphous alloy represented by the formula, (Zr)ₐ(Ni, Ti)_{b}(Ni, Cu)_{c}(Al)_{d}, where a Is 40 to 65 atomic %, b is 0.01 to 10 atomic %, c is 20 to 30 atomic %, and d is 7.5 to 15 atomic %.

U.S. Patent Application Laid-Open Publication No. 2003-0062811 also discloses amorphous alloys represented by the formulae, Zr₄₁Ti₁₄Ni₁₀Cu_{12.5}Be_{22.5},Fe₇₂Al₅Ga₂P₁₁C₆B₄, and Fe₇₂Al₇Zr₁₀Mo₅W₂B₁₅.

Another example of an amorphous alloy that may be used herein is an amorphous alloy having a composition represented by the formula, (Zr, Ga)ₐ(Ti, P, W)_{b}(V, Nb, Cr, Hf, Mo, C)_{c}(Ni)_{d}(Cu)ₑ(Fe, Co, Mn, Ru, Ag, Pd)_{f}(Be, Si, B)_{g}(Al)ₕ. Here, provided that a+b+c+d+e+f+g+h Is 100 atomic %, a+b+c is 15 to 75 atomic %, d+e+f is 5 to 75 atomic %, and g+h is 0 to 50 atomic %, preferably 0.01 to 50 atomic %. For example, Zr₄₁Ti₁₄Ni₁₀Cu₁₂₅Be₂₂₅, Fe₇₂Al₅Ga₂P₁₁C₆B₄, and Fe₇₂AI₇Zr₁₀Mo₅W₂B₁₅ may be utilized.

A corrosion rate of a bipolar plate may be directly measured in a fuel cell, In this case, however, operation of a fuel cell for an extended period of time corresponding to the life span of the fuel cell is required. In this regard, a method of predicting the corrosion rate of a bipolar plate within a short time under a simulated environment for a fuel cell is generally used. A simulated environment for a PEMFC is as follows: a bipolar plate contacts with an electrolyte (pH 3) saturated with hydrogen or oxygen at an operating temperature of about 80 to 130° C. At this time, the potentials of an anode and a cathode are respectively 0 to 0.3 V vs RHE and 0.9 to 1.2 V vs RHE. The current coming from the fuel cell environment is used as a measure for predicting the corrosion rate.

When the corrosion rate of an amorphous alloy exceeds a predetermined level, metal ions are dissolved by the corrosion of an amorphous alloy plate during the operating time of a fuel cell, thus reducing the thickness of the alloy plate. Therefore, the alloy plate cannot serve as a bipolar plate, an end plate, a cooling plate, or a separator, and loses mechanical strength, during the operating time of a fuel cell, thus causing instability of a fuel cell.

In this regard, it is preferable to use an amorphous alloy having a corrosion rate of about 20 μA/cm² or less in a hydrogen-saturated solution having a temperature of 130° C. and a pH of 3.

Because a lower corrosion rate is more advantageous, the lower limit of the corrosion rate is not particularly defined. Typically, an amorphous alloy, as used herein, may have a corrosion rate of about 1 to 20 μA/cm² in a hydrogen-saturated solution having a temperature of 130° C. and a pH of 3.

A bipolar plate of an embodiment of the present invention comprising such an amorphous alloy may have a corrosion rate of about 20 μA/cm² or less in a hydrogen-saturated solution having a temperature of 130° C. and a pH of 3.

When an amorphous alloy has an Insufficient fracture toughness, an alloy plate made of such an alloy may have a low resistance to fracture due to its defects, and thus, may not be suitable as a component of a fuel cell stack.

In this regard, an amorphous alloy as used herein generally has a fracture toughness of about 5 (ksi)−(in^{1/2}) or more.

Because a higher fracture toughness is more advantageous, the upper limit of the fracture toughness is not particularly defined. Typically, an amorphous alloy, as used herein, may have a fracture toughness of about 5 to 20 (ksi)−(in^{1/2}).

If the elastic limit of an amorphous alloy is too small, an alloy plate may be deformed by a compression pressure applied to a fuel cell stack without being returned to its original shape.

In this regard, an amorphous alloy as used herein typically has an elastic limit of about 1% or more.

Because a higher elastic limit is more advantageous, the upper limit of the elastic limit is not particularly defined. Generally, the elastic limit of an amorphous alloy as used herein may be about 1 to 2%.

A bipolar plate of an embodiment of the present invention may also be efficiently applied in a PAFC, a PEMFC, a DMFC, and the like. The dimension and channel pattern of a bipolar plate of an embodiment of the present invention may be easily determined according to an application system by ordinary persons skilled in the art, and thus, the detailed descriptions thereof will be omitted.

It is known to those skilled in the art that it is almost impossible to obtain a graphite bipolar plate with a thickness of 2-3 mm or less. For this reason, a common fuel cell stack obtained by stacking several tens to several hundreds of MEAs becomes bulky. Also, a graphite bipolar plate has an unfavorable handling property due to its fragility. On the other hand, a bipolar plate made of an amorphous alloy according to an embodiment of the present invention may have even a thickness as thin as about 0.3 mm. Therefore, use of a bipolar plate of an embodiment of the present invention enables reduction of the height of a fuel cell stack to about ½ of a fuel cell stack using a conventional graphite bipolar plate. Generally, the density of an amorphous alloy is about three times that of graphite. However, since a separating plate made of an amorphous alloy according to an embodiment of the present invention may have a thin thickness, the weight of a fuel cell stack is not increased.

A separating plate made of an amorphous alloy according to an embodiment of the present invention requires much lower material and processing costs, as compared to a conventional graphite separating plate. Therefore, the cost required for a separating plate with respect to an overall manufacturing cost of a fuel cell may be reduced to less than 1/100 of the cost for the graphite separating plate.

A separator of an embodiment of the present invention may be manufactured according to the following non-limiting method.

The present invention provides a method of manufacturing a separator of a fuel cell, which is made of a solid-state, amorphous alloy, includes: preparing a melt for formation of the solid-state, amorphous alloy; feeding the melt into a mold provided with a mold cavity having a shape corresponding to the separator; and cooling the melt in the mold cavity at a cooling rate higher than the critical cooling rate to transform the melt into an amorphous phase.

An amorphous alloy material to be melted is heated to 30° C. to 100C higher than its glass transition temperature (Tg) at a rate of 20° C./min in an inert gas atmosphere. At this time, the amorphous alloy material is changed into a supercooled liquid state. The amorphous alloy material of the supercooled liquid state is cooled at a significantly lower rate than 10⁶ K/sec. A cooling method such as cooling with a cold mold itself, splat quenching, and water melt-spinning according to the shape of a desired amorphous alloy may be used, but is not limited thereto. The solid-state, amorphous alloy thus obtained has a density of about 4.5 to 6.5 g/cm². There are no particular limitations on the amorphous alloy that may be used in this method, and the illustrative examples thereof are as described above.

As is apparent from the above description, a separating plate made of a solid-state, amorphous alloy according to an embodiment of the present invention may overcome a corrosion phenomenon, which is the most serious problem of a conventional metal separating plate, and may substitute for a conventional expensive graphite separating plate. Furthermore, a separating plate according to an embodiment of the present invention may be formed to a thinner thickness and a smaller weight, relative to a conventional graphite separating plate, thus enhancing the power density of a fuel cell.

In addition, a separating plate made of an amorphous alloy according to an embodiment of the present invention requires much lower material and processing costs, as compared to the material and processing costs of a conventional graphite separating plate. Therefore, the cost required for a separating plate with respect to an overall manufacturing cost of a fuel cell may be significantly reduced, thus resulting in reduction of an overall manufacturing cost of a fuel cell.

Although a few embodiments of the present invention have been shown and described, it would be appreciated by those skilled in the art that changes may be made in these embodiments without departing from the principles and spirit of the invention, the scope of which is defined in the claims and their equivalents.

1. A separator of a fuel cell, the separator comprising a solid-state, amorphous alloy.

2. The separator of claim 1, which has a corrosion rate approximately less than or equal to 20 μA/cm² in a hydrogen-saturated solution having a temperature of 130° C. and a pH of 3.

3. The separator of claim 1, wherein the solid-state, amorphous alloy has a fracture toughness of greater than or equal to 5 (ksi)−(in^{1/2}).

4. The separator of claim 1, wherein the solid-state, amorphous alloy has an elastic limit greater than or equal to 1%.

5. The separator of claim 1, wherein the solid-state, amorphous alloy has a composition represented by the formula, (Zr, Ga)ₐ(Ti, P, W)_{b}(V, Nb, Cr, Hf, Mo, C)_{c}(Ni)_{d}(Cu)ₑ(Fe, Co, Mn, Ru, Ag, Pd)_{f}(Be, Si, B)_{g}(Al)ₕ, where a+b+c is 15 to 75 atomic %, d+e+f is 5 to 75 atomic %, and g+h is 0 to 50 atomic %, provided that a+b+c+d+e+f+g+h is 100 atomic %.

6. The separator of claim 5, wherein the solid-state, amorphous alloy has a composition of Zr₄₁Ti₁₄Ni₁₀Cu_{12.5}Be_{22.5}.

7. The separator of claim 5, wherein the solid-state, amorphous alloy has a composition of one of: Fe₇₂Al₅Ga₂P₁₁C₆B₄ and Fe₇₂Al₇Zr₁₀Mo₅W₂B₁₅.

8. A fuel cell, comprising:
an anode;
a cathode;
an electrolyte membrane disposed between the anode and the cathode, being on a first side of the anode and the cathode; and
at least one separator proximate to one of: the anode and the cathode, the separator being disposed on a side of the anode/cathode opposite to the electrolyte membrane, and comprising a solid-state, amorphous alloy.

9. The fuel cell of claim 8, wherein the at least one separator has a corrosion rate less than or equal to 20 μA/cm² in a hydrogen-saturated solution having a temperature of 130° C. and a pH of 3.

10. The fuel cell of claim 8, wherein the solid-state amorphous alloy has a fracture toughness of greater than or equal to 5 (ksi)−(in^{1/2}).

11. The fuel cell of claim 8, wherein the solid-state, amorphous alloy has an elastic limit greater than or equal to 1%.

12. The fuel cell of claim 8, wherein the solid-state, amorphous alloy has a composition represented by the formula, (Zr, Ga)ₐ(Ti, P, W)_{b}(V, Nb, Cr, Hf, Mo, C)_{c}(Ni)_{d}(Cu)ₑ(Fe, Co, Mn, Ru, Ag, Pd)_{f}(Be, Si, B)_{g}(Al)ₕ, where a+b+c is 15 to 75 atomic %, d+e+f is 5 to 75 atomic %, and g+h is 0 to 50 atomic %, provided that a+b+c+d+e+f+g+h is 100 atomic %.

13. The fuel cell of claim 12, wherein the solid-state, amorphous alloy has a composition of Zr₄₁Ti₁₄Ni₁₀Cu_{12.5}Be_{22.5}.

14. The fuel cell of claim 12, wherein the amorphous alloy has a composition of one of: Fe₇₂Al₅Ga₂P₁₁C₆B₄ and Fe₇₂Al₇Zr₁₀Mo₅W₂B₁5.

15. A method of manufacturing a separator of a fuel cell, the separator comprising a solid-state, amorphous alloy, the method comprising:
preparing a melt to transform the solid-state, amorphous alloy;
feeding the melt into a mold provided with a mold cavity having a shape corresponding to the separator; and
cooling the melt In the mold cavity at a cooling rate higher than a critical cooling rate to transform the melt into an amorphous phase.

16. The method of claim 15, wherein the solid-state, amorphous alloy has a corrosion rate less than or equal to 20 μA/cm² in a hydrogen-saturated solution having a temperature of 130° C. and a pH of 3.

17. The method of claim 15, wherein the solid-state, amorphous alloy has a fracture toughness greater than or equal to 5 (ksi)−(in^{1/2}).

18. The method of claim 15, wherein the solid-state, amorphous alloy has an elastic limit greater than or equal to 1%.

19. The method of claim 15, wherein the solid-state, amorphous alloy has a composition represented by the formula, (Zr, Ga)ₐ(Ti, P, W)_{b}(V, Nb, Cr, Hf, Mo, C)_{c}(Ni)_{d}(Cu)ₑ(Fe, Co, Mn, Ru, Ag, Pd)_{f}(Be, Si, B)_{g}(Al)ₕ, where a+b+c is 15 to 75 atomic %, d+e+f is 5 to 75 atomic %, and g+h is 0 to 50 atomic %, provided that a+b+c+d+e+f+g+h is 100 atomic %.

20. The method of claim 19, wherein the solid-state, amorphous alloy has a composition of one of: Zr₄₁Ti₁₄Ni₁₀Cu_{12.5}Be_{22.5}, Fe₇₂Al₅Ga₂P₁₁C₆B₄ and Fe₇₂Al₇Zr₁₀Mo₅W₂B₁₅.
